(19) United States
(12) Patent Application Publication
(10) Pub. No.: US 2022/0089016 A1
(43) Pub. Date: Mar. 24, 2022

(54) INTUMESCENT COATED VENT FOR LARGE PASSENGER VEHICLES

(71) Applicant: SIKA TECHNOLOGY AG, Baar (CH)

(72) Inventor: Stuart SELWOOD, Dudley (GB)

(73) Assignee: SIKA TECHNOLOGY AG, Baar (CH)

(21) Appl. No.: 17/423,671

(22) PCT Filed: Apr. 2, 2020
(86) PCT No.: PCT/EP2020/059395

§ 371 Date: Jul. 16, 2021

(30) Foreign Application Priority Data
Apr. 3, 2019 (EP) 19166944.9

(51) Int. Cl. B60K 11/08; B60R 19/52; A62C 2/06; C09D 163/00; C08K 3/32; C08K 5/06

(52) U.S. Cl. CPC B60K 11/08; B60R 19/52; A62C 2/065; C08K 2003/323; C08K 3/32; C08K 5/06; B60R 2019/525; C09D 163/00

(57) ABSTRACT

A vent with louvres or punched holes for allowing airflow between an exterior of a vehicle and an engine bay of the vehicle, wherein the vent has an exterior side and an interior side and is formed from a panel, in which the louvres or the punched holes are located, wherein the interior side of the vent is provided with an intumescent coating. The intumescent coating will inhibit the spread of flame from the engine bay to the exterior of the vehicle thus containing the fire for a much longer period.

### TECHNICAL FIELD

The invention relates to an intumescent coated vent for vehicles, in particular large passenger vehicles, as a mean for fire suppression.

### BACKGROUND OF THE INVENTION

Fires that escape engine bays to the outside of buses put life at risk and cost bus operators significantly more in repairs or total loss when the fire isn't extinguished soon enough.

Thus, 1400 bus fires were reported in the UK in the last 10 years, 71% from engine bay. As a result, 26 deaths recorded and over 400 buses classed as total loss (not able to repair). Average bus fire attendance times by the UK fire service (2017) is 9.5 mins. Most total loss are due to fire service not able to attend quickly. Also older buses more susceptible to engine bay fires and more rural areas where fire service may take longer to attend will likely have a much older fleet.

Engines of a vehicle require air exchange during operation by means of an airflow from the exterior. The airflow is generally achieved by a vent mounted in a part of the vehicle body, which divides the engine bay from the exterior of the vehicle. In case of a fire, however, the airflow through the vent supports fire development and allows the fire to spread to the outside, which is highly undesirable. The amount of air exchange required is generally larger for large passenger vehicles such as buses so that the dimension of the vent must be adapted accordingly.

Existing regulations on fire protection for large passenger vehicles such as an EU directive on fire protection mainly concern active fire suppression systems for engine compartments of buses and coaches. Active fire suppression systems are however expensive and space consuming.

### SUMMARY OF THE INVENTION

The object of the invention was to provide a vent for allowing airflow between an exterior of a vehicle, in particular a large passenger vehicle, and an engine bay of the vehicle, wherein the vent should inhibit spread of flame to the outside of the vehicle at least for a certain time in case of an engine bay fire. The solution should be a low cost solution.

It was found that the vent according to claim 1 fulfils this object and has additional advantages. Accordingly, the invention provides a vent with louvres or punched holes for allowing airflow between an exterior of a vehicle and an engine bay of the vehicle, wherein the vent has an exterior side and an interior side and is formed from a panel, in which the louvres or the punched holes are located, characterized in that the interior side of the vent is provided with an intumescent coating.

The intumescent coating activates when engine bay fire is present and expand to fill the gaps between the vents louvres or to cover the punched holes. As a result, the intumescent coating will inhibit the spread of flame from the engine bay to the exterior of the vehicle thus containing the fire for a much longer period to allow emergency services the time to attend and extinguish the fire. Accordingly, the invention provides an engine bay fire suppression. A restriction of spread of flame can be achieved.

The beneficial technical effect relies inter alia in the fact that the inventive configuration with the intumescent coating provided on the interior side of the vent allows for a faster and more direct heat input into the intumescent coating so that the swelling and closing or sealing mechanism takes place very fast.

The invention can be easily implemented in known vent systems used for vehicles and presents a low cost solution. The additional costs for the inventive system with an intumescent coating can be less than one-tenth the cost of a conventional active fire suppression system in use today.

The presented solution is not only suitable for new build but also for retrofit of conventional vents in aftermarket.

Other aspects of the invention are revealed in other independent claims. Preferred aspects of the invention are revealed in the dependent claims.

### BRIEF DESCRIPTION OF THE DRAWINGS

The subject matter of the invention is illustrated by way of example in the drawings wherein

FIG. 1 shows schematically a plan of an embodiment of an inventive vent,

FIG. 2 shows schematically a front elevation of the embodiment of FIG. 1,

FIG. 3 shows schematically a side elevation of the embodiment of FIG. 1,

FIG. 4 shows schematically a plan of another embodiment of an inventive vent,

FIG. 5 shows schematically a front elevation of the embodiment of FIG. 4,

FIG. 6 shows schematically a side elevation of the embodiment of FIG. 4.

### DETAILED DESCRIPTION OF THE INVENTION

The vent of the invention is a vent with louvres or punched holes for allowing airflow between an exterior of a vehicle and an engine bay of the vehicle. Such vents are conventionally used to allow airflow or air exchange to engine bays of vehicles, primarily buses.

The vent has an exterior side and an interior side. The exterior side refers to the side which is to face the exterior or outside of the vehicle, when the vent according to the invention is mounted on a vehicle. The interior side refers to the side which is to face the interior of the engine bay of the vehicle, when the vent according to the invention is mounted on a vehicle.

In this application, indications of spatial relations with respect to the invention refer to a vent mounted on the vehicle, if necessary and unless stated otherwise.

The vent is formed from a panel, in which the louvres or the punched holes are located. The panel can be composed of one part or two or more parts. The panel and the louvres may be made of the same or a different material, wherein the same material is preferred. Suitable materials are for instance metal or galvanized metal. Examples of suitable metals are steel, stainless steel or aluminium. Also, other materials may be used. Even plastics including fiberglass-reinforced plastics, or other composite materials, may be suitable. Of course, the material must fulfil the mechanical and thermal requirements for such applications.

The vent or the panel, respectively, may be planar or corrugated. A vent with louvres is preferably planar. A vent with punched holes may be planar or corrugated, wherein a corrugated vent with punched holes also refers to a vent where a portion thereof has a corrugated configuration. The dimensions of the vent is adapted to the specific use of the vent.

The vent with louvres or punched holes is preferably a vent with louvres. A vent with louvres is also called louvre vent or simply louvre. In the case of a vent with louvres, the panel may be for instance in form of a frame on which the louvres are attached. The louvres may be also integral with the panel, i.e. panel and louvres are made of one piece.

In a preferred embodiment, the louvres of the vent are located on the interior side of the vent, i.e. the louvres protrude into the engine bay and not into the exterior. The intumescent coating is preferably provided one side or on both sides of the louvres, more preferably on both sides of the louvres.

It is preferred that the louvres face each other. Vents with louvres that face each other in their design are the best possible option for the maximum impact.

Louvres of the vent can be in a fixed position or the position can be adjustable, but in general the louvres are fixed louvres.

The louvres of the vent are preferably inclined. This refers to the angle between the plane of the vent or panel, respectively, and the plane of the louvres. The louvre angle is preferably in the range of 10° to 60°, more preferably 15° to 45°. The inclined louvers may be directed upwards or downwards, preferably upwards.

The louvres can have e.g. a straight shape, an angled shape or a curved shape in cross section. Other more complex shapes are also conceivable. The louvres may be e.g. arranged horizontally or vertically, wherein a horizontal arrangement is preferred.

The gaps between the louvres of the vent allow for airflow or air exchange between the exterior and the engine bay of a vehicle. The gaps may be e.g. slit-shaped. The dimension of gap height as well as the other dimensions of the vent depend on the intended use. The gap height may be e.g. in the range of 5 to 70 mm, preferably 10 to 50 mm. The height of the gap refers to direction perpendicular to the length direction of the louvers.

The louvres preferably have a length from 30 cm to 150 cm, especially from 50 cm to 120 cm, more preferably from 80 cm to 100 cm. It is further preferred if the louvres have a thickness from 1 mm to 10 mm, especially from 2 mm to 6 mm, more preferably from 2 mm to 4 mm.

In the alternative embodiment, the vent is a vent with punched holes. In the case of a vent with punched holes, the panel may be sheet-like panel in which the punched holes are present. It is also possible that the panel is composed of a frame part and a sheet-like panel in which the punched holes are present, wherein the sheet-like panel may be integral with the frame part or mounted thereon. The sheet-like panel may be planar or have a corrugated configuration.

The punched holes may have any suitable shape, wherein it is preferred that the punched holes have a circular shape. The dimension of the punched holes as well as the other dimensions of the vent depend on the intended use. The punched holes may be arranged in an array of rows and columns. In general, the area of the punched holes may account for a significant proportion of the total area of panel including the area of the punched holes, e.g. at least about 20%, preferably at least about 40%, of the total area.

In the case of a vent with punched holes, the panel preferably has a thickness from 1 mm to 10 mm, especially from 2 mm to 6 mm, more preferably from 2 mm to 4 mm. It is further preferred if the diameter of the punched holes, especially if the punched holes have a circular shape, is from 2 mm to 20 mm, especially from 5 mm to 15 mm, more preferably from 7.5 mm to 12.5 mm. The distance between the punched holes is preferably from 3 mm to 15 mm, especially from 5 mm to 12.5 mm, more preferably from 7.5 mm to 10 mm.

In a preferred embodiment, the vent is arranged in the vehicle so that the panel of the vent is in the same plane as the plane of the part of the vehicle body it is attached to or parallel to that plane, in particular with respect to the embodiment related to punched holes. That is, the panel is arranged essentially perpendicular to the direction from the external side to the internal side.

An essential feature of the vent with louvres or punched holes according to the invention is that the interior side of the vent is provided with an intumescent coating. Intumescent coatings swells as a result of heat exposure, thus increasing in volume and decreasing in density. Intumescent coatings are known to the skilled person.

In general, the intumescent coating includes a binder and an intumescent formulation. The intumescent formulation may include three functional components, namely an acid source, a carbonific compound, and a blowing agent generating non-combustible gases such as NH₃ or CO₂. Examples for an acid source are ammonium phosphate, ammonium polyphosphate (APP), diammonium diphosphate or diammonium pentaborate. Examples for a carbonific compound are polyhydroxy compounds such as pentaerythritol (PER). Examples for a blowing agent are melamine and guanidine. There are compounds that may function in more than one way, for instance, ammonium polyphosphate (APP) acts both as an acid source and as a blowing agent.

In a preferred embodiment, the intumescent coating is an intumescent epoxy coating or an epoxy coating containing an intumescent formulation. Accordingly, the binder used for the coating is preferably an epoxy resin. The intumescent coating, preferably the intumescent epoxy coating, preferably contains ammonium polyphosphate. More preferably, the intumescent coating is an epoxy coating containing ammonium polyphosphate and a polyol, preferably pentaerythritol.

It has been found that particular good results can be achieved when the intumescent coating is obtained from a two component coating composition consisting of a particular component A and a particular component B as defined below. Intumescent coatings obtained from such a two component coating composition shows a particular good swelling behaviour in the conditions of an engine bay fire so that an improved restriction of spread of flame can be achieved.

Accordingly, according to a particularly preferred embodiment of the invention the intumescent coating is obtained by mixing a component A and a component B to obtain a coating composition, applying the coating composition on the vent surface to be coated and curing the coating composition, wherein
component A comprises, based on the total weight of component A,

10-70% by weight of at least one liquid epoxy resin,

10-70% by weight of ammonium polyphosphate, and

1-15% by weight of at least one compound selected from the group consisting of pentaerythritol, dipentaerythritol, tripentaerythritol, polycondensates of pentaerythritol and pentaerythritol-based esters and polyols, preferably pentaerythritol and/or dipentaerythritol,

and component B comprises at least one curing agent for epoxy resins, wherein the curing agent is preferably is at least one aliphatic, cycloaliphatic and/or arylaliphatic primary diamine.

More specifically, the coating composition for obtaining the intumescent coating comprises, before curing, a component A and a component B. The component A comprises 10-70% by weight of at least one liquid epoxy resin, based on the total weight of component A.

The liquid epoxy resin has, on average, more than one epoxide group per molecule. The term “epoxy liquid resin” is well known to the person skilled in the art and is used in contrast to “solid epoxy resins”. The glass transition temperature of solid resins is above room temperature, i.e. they can be ground at room temperature to give pourable powders.

Preferred liquid epoxy resins have the formula (I)

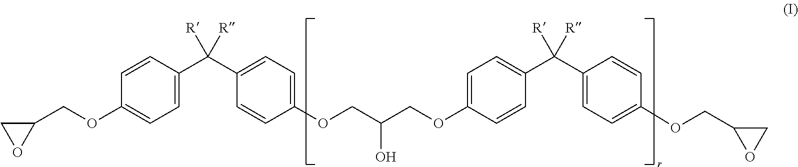

Here, the substituents R′ and R″ independently represent either H or CH₃. Furthermore, the index r stands for a value of 0 to 1. Preferably, r stands for a value of less than 0.2.

Thus, the liquid epoxy resins are preferably diglycidyl ethers of bisphenol A (DGEBA), of bisphenol F or of bisphenol A/F. Such liquid resins are e.g. commercially available by Araldite® GY 250, Araldite® PY 304, Araldite® GY 282 (Huntsman) or D.E.R™ 331 or D.E.R™ 330 (Dow) or Epikote 828 (Hexion).

Also suitable as epoxy liquid resin are so-called novolaks. These have preferably the following formula:

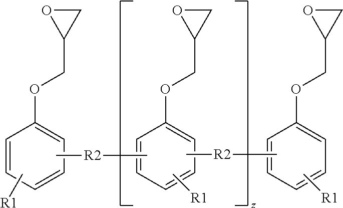

with R2=

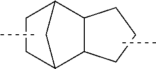

or CH₂, R1=H or methyl and z=0 to 2, in particular z=0 to 1.

In particular, these are phenol or cresol novolaks (R2=CH2). Such epoxy resins are commercially available under the tradename EPN or ECN and Tactix® 556 from Huntsman or under the product line D.E.N.™ from Dow Chemical.

Preferably, the liquid epoxy resin is an epoxy liquid resin of the formula (I).

The component A comprises 10-70% by weight ammonium polyphosphate, based on the total weight of component A. Preferably, the ammonium polyphosphate has a particle size of ≤100 μm, in particular 50 μm-5 μm.

It is further advantageous if the ammonium polyphosphate is an ammonium polyphosphate of the formula (NH₄PO₃)ₙ wherein n is 200-2000, preferably 600-1500.

Substance names beginning with “poly”, such as polyphosphate or polyol, refer to substances that formally contain two or more of the functional groups occurring in their name per molecule.

In the present document, by “molecular weight” is meant in oligomers or polymers the average molecular weight, which is usually determined by GPC.

The component A comprises 1-15% by weight of at least one compound selected from the group consisting of pentaerythritol, dipentaerythritol, tripentaerythritol, polycondensates of pentaerythritol and pentaerythritol-based esters and polyols, based on the total weight of component A, wherein the compound is preferably selected from pentaerythritol or dipentaerythritol, in particular pentaerythritol.

Preferably, the component A has a viscosity of 1000-10000 mPa, in particular 1000-4000 mPa, measured at a temperature of 23° C. and a shear rate of 100 sec⁻¹.

The component B comprises at least one curing agent for epoxy resins.

Preferably, the curing agent for epoxy resins is at least one aliphatic, cycloaliphatic and/or arylaliphatic primary diamine, in particular ethylenediamine, 1,2-propanediamine, 1,3-propanediamine, 2-methyl-1,2-propanediamine, 2,2-dimethyl-1,3-propanediamine, 1,3-butanediamine, 1, 4-butanediamine, 1, 3-pentanediamine (DAMP), 1, 5-pentanediamine, 1,5-diamino-2-methylpentane (MPMD), 2-butyl-2-ethyl-1, 5-pentanediamine (C11-neodiamine), 1,6-hexanediamine, 2,5-dimethyl-1,6-hexanediamine, 2,2,4- and 2,4,4-trimethylhexamethylenediamine (TMD), 1,7-heptanediamine, 1,8-octanediamine, 1, 9-nonanediamine, 1,10-decanediamine, 1,11-undecanediamine, 1,12-dodecanediamine, 1,2-, 1,3- and 1,4-diaminocyclohexane, 1,4-diamino-2,2,6-trimethylcyclohexane (TMCDA), bis (4-aminocyclohexyl) methane (H₁₂-MDA), bis (4-amino-3-methylcyclohexyl) methane, bis (4-amino-3-ethylcyclohexyl) methane, bis (4-amino-3,5-dimethylcyclohexyl) methane, bis (4-amino-3-ethyl-5-methylcyclohexyl) methane (M-MECA), 1-amino-3-aminomethyl-3,5,5-trimethylcyclohexane (=isophoronediamine or IPDA), 2- and 4-methyl 1,3-diaminocyclohexane and mixtures thereof, 1,3- and 1,4-bis (aminomethyl) cyclohexane, 2,5(2,6) bis (aminomethyl) bicyclo [2.2.1] heptane (NBDA), 3(4), 8(9)-bis (aminomethyl)-tricyclo [5.2.1.0^{2,6}] decane, 1, 8-menthanediamine and 1,3- and 1,4-bis (aminomethyl) benzene.

Particularly preferably, the curing agent is a cycloaliphatic primary diamine, preferably 1-amino-3-aminomethyl-3,5,5-trimethylcyclohexane (=isophorone diamine or IPDA). A further particularly preferred curing agent is at least one arylaliphatic primary diamine, preferably 1,3-bis (aminomethyl) benzene.

Most preferably, the curing agent for epoxy resins includes a mixture of two different curing agents, wherein the first and second curing agents are selected from aliphatic, cycloaliphatic and/or arylaliphatic primary diamines. Preferably, the first curing agent is a cycloaliphatic primary diamine, preferably 1-amino-3-aminomethyl-3,5,5-trimethylcyclohexane (=isophorone diamine or IPDA) and the second curing agent is an arylaliphatic primary diamine, preferably 1,3-bis (aminomethyl) benzene. It is particularly preferred that for the use of two curing agents as discussed above, the weight ratio of first curing agent to second curing agent is 1:0.5-2, in particular 1:0.8-1.5.

Preferably, the component B has a viscosity of 50-2000 mPa, in particular 50-500 mPa, measured at a temperature of 23° C. and a shear rate of 100 sec⁻¹.

The components A and B are preferably mixed in a weight ratio A:B of 1:0.5-2, in particular 1:0.8-1.2. The viscosity of the coating composition, 30 seconds after the mixing of component A with component B, is preferably from 1000-5000 mPa, in particular 1500 to 3000 mPa, measured at a temperature of 23° C. and a shear rate of 100 sec⁻¹.

The coating composition is preferably liquid when it is applied on the surface of the vent. The coating composition can be applied by conventional means, preferably by means of a spraying device, a brush or a roller.

In general, the intumescent coating is preferably obtained by application of a liquid coating composition containing an intumescent formulation on the vent surface to be coated and curing the coating composition applied. The coating composition is preferably applied by spraying or brushing. For manufacture of vents in a large scale applications, spraying is generally more cost effective, whereas for a limited number of vents brushing may be more appropriate.

It is particularly preferred that the layer thickness of the intumescent coating is generally designed such that the expansion of the intumescent coating during an engine bay fire fills the gaps between the vents louvres, in case of a vent with louvres, or covers the punched holes, in the case of a vent with punched holes.

For instance, in order to achieve a complete filling of the gaps for a vent with louvres the thickness of the intumescent coating applied is calculated based on the expansion rate of the intumescent coating used and the size of the gaps between the louvers. It is usually recommendable to consider also a safety margin for this calculation. The expansion rate of the intumescent at the targeted fire conditions is known or can be easily obtained by trials.

As a specific example for the calculation: If the gaps between the louvres of the vent are 30 mm in height and the louvers are provided on both sides with the intumescent coating expanding 50 times its original thickness from both sides in case of fire, a thickness of 1 mm for the intumescent coating is adequate with some safety factor built in. An adequate thickness in case of a vent with punched holes in order to achieve a complete covering or sealing of the punched holes can be calculated analogously.

The intumescent coating preferably has a layer thickness in the range of 0.8 mm to 4 mm, more preferably 1 mm to 4 mm, in particular for the vent with louvres.

As mentioned, the intumescent coating is provided on the interior side of the vent. The interior side may be completely covered with the intumescent coating but it may be sufficient that the interior side is only partly covered with the intumescent coating as long as the desired closure of the gaps or punched holes, respectively, can be achieved in case of a fire. For instance, the periphery of the panel may be distant from the gaps or punched holes and may mainly serve for mounting purposes so that an intumescent coating on these regions is not necessary. It may be sufficient that one or both sides of the louvres are provided with the intumescent coating.

The exterior side of the vent may also be provided with the intumescent coating. This is, however, not preferred since it is not necessary to achieve the advantages of the invention. Therefore, it is preferred that the exterior side of the vent is not provided with the intumescent coating. The exterior side of the vent may be coated instead with a coating which is different from an intumescent coating, for instance a colour coating, if desired.

It is a further benefit of the present invention that it is not necessary to coat the exterior side of the vent with the intumescent coating. It is generally desired that the exterior surface of the vehicle has a homogenous appearance which is deteriorated if the intumescent coating is on the exterior side of the vent. Moreover, the exterior side of the vent can be provided e.g. with a colour coating for aesthetic reasons. The presence of the intumescent coating on the exterior side could impede such colour coating.

The vehicle on which the vent of the invention is to be mounted is preferably a large passenger vehicle, in particular a bus such as a city bus or a coach.

The present invention is also directed to a vehicle comprising a vent according to the invention as described above, wherein the vent is mounted in a part of the vehicle body, which divides the engine bay of the vehicle from the exterior of the vehicle. It goes without saying that the part of the vehicle body has an opening for reception of the vent to be mounted.

The present invention is also directed to the use of a vent according to the invention as described above in a vehicle as a fire control system for engine bay fires.

It goes without saying that the vehicle according to the invention or for the use of the vent as claimed is also preferably a large passenger vehicle, in particular a bus such as a city bus or a coach.

The invention will now be explained in more detail by way of the drawings attached and an example for the intumescent coating. These are intended to further illustrate the invention, but in no way limit the scope of the invention.

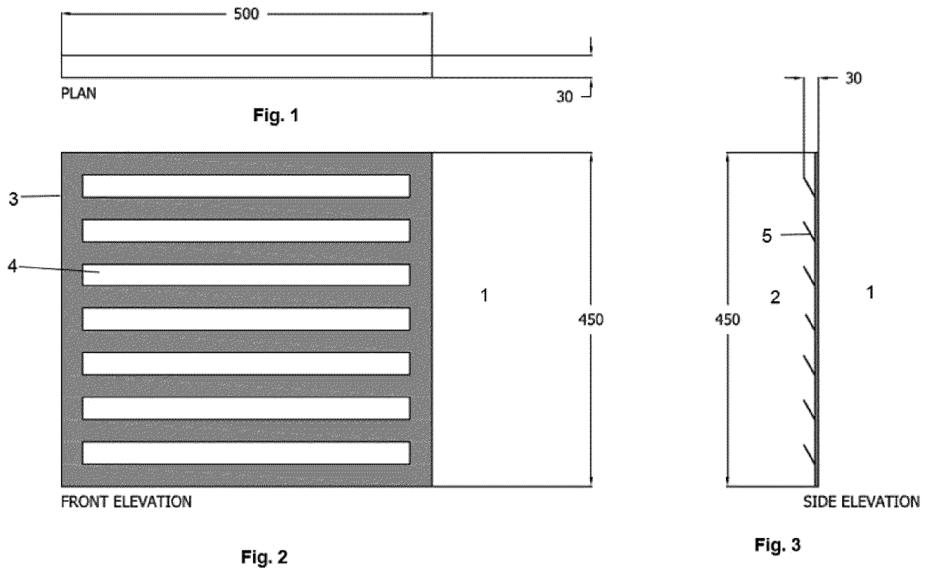

FIG. 1 shows schematically a plan of an inventive vent. A front elevation and a side elevation of this inventive vent are shown in FIG. 2 and FIG. 3, respectively. The vent is a vent with louvres 5. Exemplary dimensions of the vent are given in units of millimetres. The front elevation of FIG. 2 shows the exterior side 1 of the vent. The panel 3 is composed of one part in which the gaps 4 for allowing airflow between the exterior and the engine bay of a vehicle are located. The gap height is e.g. about 30 mm. The side elevation of FIG. 3 shows the louvres located on the interior side 2 of the vent. The louvres 5 are inclined and directed upwards. The gaps 4 are located between the louvres 5. Both sides of the louvres 5 are provided with an intumescent coating (not explicitly shown) as explained in the Coating Example below. The thickness of the intumescent coating may be e.g. 1 mm.

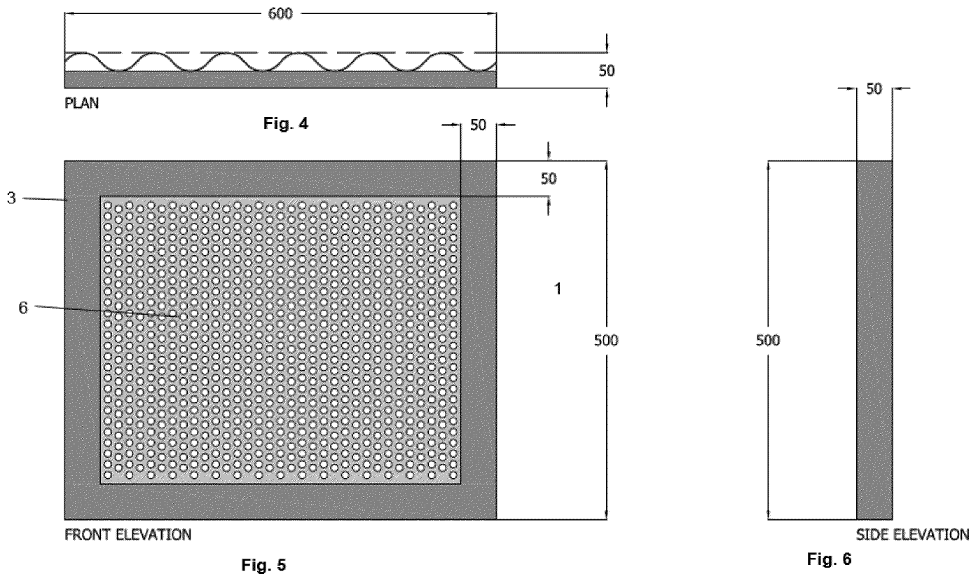

FIG. 4 shows schematically a plan of another embodiment of an inventive vent. A front elevation and a side elevation of this inventive vent are shown in FIG. 5 and FIG. 6, respectively. The vent is a vent with punched holes 6. Exemplary dimensions of the vent are given in units of millimetres. The front elevation of FIG. 5 shows the exterior side 1 of the vent. The panel 3 is composed of a frame part and a sheet-like panel in which the punched holes 6 for allowing airflow between the exterior and the engine bay of a vehicle are located. The sheet-like panel has a corrugated configuration. The interior side may by symmetrical with the exterior side of the vent. The interior side is provided with an intumescent coating (not shown) as explained in the Coating Example below. The intumescent coating may be provided on both the frame part and the sheet-like panel of the panel or only on the sheet-like panel. The thickness of the intumescent coating may be e.g. 1 mm.

Coating Example

The following materials were used to prepare a coating composition which is suitable for the intumescent coating of the vent of the invention:

| | tradename, producer |
|---|---|
| component A | |
| liquid epoxy resin | Araldite ® PY 304, Huntsman |
| ammonium polyphosphate | Exolit ® AP 422, Clariant |
| pentaerythritol | Charmor, Perstorp Speciality |
| | Chemicals |
| component B | |
| 1-amino-3-aminomethyl- | Vestamin ® IPD, Evonik |
| 3,5,5-tri-methylcyclohexane | |
| 1,3-bis-(aminomethyl) | Itochu Corp. |
| benzene | |

A component A was prepared which includes 35% by weight of the liquid epoxy resin, 45% by weight of ammonium polyphosphate, and 5% by weight of pentaerythritol.

A component B was prepared which includes 25% by weight of 1-amino-3-aminomethyl-3,5,5-trimethylcyclohexane, and 25% by weight of 1,3-bis-(aminomethyl) benzene.

Components A and B were mixed, preferably with in a weight ratio of component A to component B of about 1:0.8-1.2, e.g. 1:1, to prepare an intumescent coating composition. The coating composition was applied in a liquid state on the interior side of a vent by spraying or brushing. The thickness of the intumescent coating obtained after cure is preferably in the range of 0.8 mm to 4 mm, more preferably 1 mm to 4 mm.

Fire Test

A vent with louvers with a gap height of about 30 mm as shown in FIG. 1 to 3 was used for a fire test. Both sides of the louvers were coated with an intumescent coating as described in the Coating Example above (coating thickness e.g. about 1 mm). The exterior side of the vent was not coated.

A flame gun was used to replicate internal engine bay fire. The flame gun brought in close proximity to the vent was directed to the interior side of the vent. The aim was to see if the intumescent coating will increase in size enough to block the vent and will effectively stop the fire from spreading outside of the vehicle, i.e. to the exterior side of the vent, and to see how long the intumescent coating will stay stable and stop flames.

A significant success was observed. The fire in the test was subdued within 3 mins. After 20 mins the fire was still not escaping (it went on to 26 mins before the test was stopped).

A secondary test was performed using the same methodology but with a slightly higher intensity of the flame gun and the only difference observed was that the coating responded more quickly so fire was suppressed after 2.5 mins.

### REFERENCE LIST

1 exterior side of the vent
2 interior side of the vent
3 panel
4 gap
5 louvre
6 punched hole

1. A vent with louvres or punched holes for allowing airflow between an exterior of a vehicle and an engine bay of the vehicle, wherein the vent has an exterior side and an interior side and is formed from a panel, in which the louvres or the punched holes are located, wherein the interior side of the vent is provided with an intumescent coating.

2. The vent according to claim 1, wherein the louvres are located on the interior side of the vent and the intumescent coating is provided one side or on both sides of louvres.

3. The vent according to claim 1, wherein the louvres face each other.

4. The vent according to claim 1, wherein the louvres are fixed louvres.

5. The vent according to claim 1, wherein the louvres are inclined.

6. The vent according to claim 1, wherein the punched holes have a circular shape.

7. The vent according to claim 1, wherein the intumescent coating is an epoxy coating containing an intumescent formulation.

8. The vent according to claim 1, wherein the intumescent coating is obtained by mixing a component A and a component B to obtain a coating composition, applying the coating composition on the vent surface to be coated and curing the coating composition, wherein
component A comprises, based on the total weight of component A,
10-70% by weight of at least one liquid epoxy resin,
10-70% by weight of ammonium polyphosphate, and
1-15% by weight of at least one compound selected from the group consisting of pentaerythritol, dipentaerythritol, tripentaerythritol, polycondensates of pentaerythritol and pentaerythritol-based esters and polyols,
and component B comprises at least one curing agent for epoxy resins.

9. The vent according to claim 8, wherein the liquid epoxy resins have the formula (I) 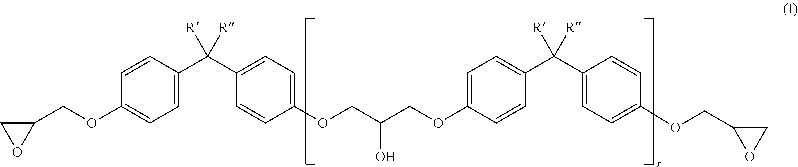
wherein the substituents R′ and R″ independently represent either H or CH₃, and the index r stands for a value of 0 to 1.

10. The vent according to claim 1, wherein the layer thickness of the intumescent coating is designed such that the expansion of intumescent coating during an engine bay fire fills the gaps between the vents louvres or covers the punched holes.

11. The vent according to claim 1, wherein the layer thickness of the intumescent coating is in the range of 0.8 to 4 mm.

12. The vent according to claim 1, wherein the exterior side of the vent is not provided with the intumescent coating.

13. A vehicle comprising a vent according to claim 1 which is mounted in a part of the vehicle body, which divides the engine bay of the vehicle from the exterior of the vehicle.

14. The vehicle according to claim 13, wherein the vehicle is a large passenger vehicle.

15. A fire control system for engine bay fires in a vehicle, comprising the vent according to claim 1.
